(19) United States
(12) Patent Application Publication
(10) Pub. No.: US 2011/0074692 A1
(43) Pub. Date: Mar. 31, 2011

(54) Devices and Methods for Conforming a Virtual Keyboard

(75) Inventors: Mark Edward Causey, Tucker, GA (US); Adrianne Binh Luu, Roswell, GA (US); Michael Robert Zubas, Marietta, GA (US)

(73) Assignee: AT&T MOBILITY II LLC, Atlanta, GA (US)

(21) Appl. No.: 12/571,239

(22) Filed: Sep. 30, 2009

(51) Int. Cl. G06F 3/02

(52) U.S. Cl. 345/169; 345/173

(57) ABSTRACT

Devices and methods are disclosed which relate to improving the efficiency of text input by generating a dynamic virtual keyboard. Examples display a soft keyboard on a touchscreen of a text-entry device. The touchscreen works with the soft keyboard as a form of text input. Keyboard logic on the text-entry device allows the user to select a desired layout for the keyboard, such that the user can change the ergonomics of the keyboard in order to make text input more comfortable. Different layouts reflect different typing styles, hand positions, etc.

### BACKGROUND OF THE INVENTION

1. Field of the Invention

The present invention relates to text-entry devices. More specifically, the present invention relates to generating a customized keyboard on a text-entry device.

2. Background of the Invention

Texting and messaging have become increasingly popular among wireless users. Texting gives users a quick and easy way to send a note to someone else without necessarily interrupting. Cellular providers have created a category of Quick Messaging Devices that are consumer based, messaging centric phones that utilize a virtual or physical full QWERTY keyboard to make typing easier. Within the span of less than a year, this segment has grown at a double digit rate.

The current text input methods on mobile devices are quite cumbersome. The hard keyboards as in BLACKBERRY devices require triple tap to input one character. This problem has been overcome to an extent with soft keyboards on IPHONES, but yet soft keyboards require a careful positioning of the finger on the character to prevent mistyping. Virtual full-QWERTY keyboards are becoming increasingly popular on hand held mobile devices for text and numeric entry. Devices like the SAMSUNG ETERNITY, BLACKBERRY BOLD, and APPLE IPHONE all utilize a fixed virtual QWERTY keyboard in which the keypad is laid out in a fixed linear fashion. Companies have created physical QWERTY keyboards that are arranged in a slightly concave shape (like a smile) to address ergonomics and produce a better text entry experience. However the keyboard is fixed and therefore one size must fit all that buy it. Virtual keyboards have not implemented any kind of ergonomic design. In the desktop world, a customer can buy a linear keyboard or a split, angular keyboard for better ergonomics but this requires a hardware change.

Users have different ways of using their fingers to input text depending on the type of keyboard utilized on their device and personal preference. Thumb typing has become popular due to the smaller size of keyboards onboard cellular telephones and other handheld devices. Many users have already been using their thumbs to input text in predictive text mode, or T9, on a twelve button keypad.

Some innovations in mobile or handheld keyboard technology have made the mobile keyboard to look like an ergonomic full-size keyboard, but smaller. While this is a good start, finger-typing can have very different ergonomics than thumb-typing. The full-size keyboard was specifically planned for a user to use eight fingers with hands side-by-side. Now that keyboard has become so well-known among the general population that it has been incorporated into handheld devices largely because any other layout requires the user to learn a whole new keyboard. While many users have become accustomed to thumb-typing, the keyboard still largely reflects the same keyboard developed for finger-typing.

What is needed is a keyboard that can be customized to the user. The user should have a choice in a keyboard layout that is best suited for their typing style.

### SUMMARY OF THE INVENTION

The present invention includes systems and methods for improving the efficiency of text input by generating a dynamic virtual keyboard. Exemplary embodiments of the present invention display a soft keyboard on a touchscreen of a text-entry device. The touchscreen works with the soft keyboard as a form of text input. Keyboard logic on the text-entry device allows the user to select a desired layout for the keyboard, such that the user can change the ergonomics of the keyboard in order to make text input more comfortable. Different layouts reflect different typing styles, hand positions, etc.

In one exemplary embodiment, the present invention is a text-entry device for generating a dynamic virtual keyboard. The text-entry device includes a processor, a memory in communication with the processor, a touchscreen in communication with the processor, a keyboard logic stored on the memory, and a custom layout database stored on the memory. The keyboard logic displays a dynamic keyboard selected by the user from the custom layout database on the touchscreen.

In another exemplary embodiment, the present invention is a method of using a text-entry device having a touchscreen and a database including a plurality of custom keyboard layouts. The method includes displaying a first dynamic keyboard selected by the user from the custom layout database, receiving a layout command, and replacing the displayed first dynamic keyboard with a second dynamic keyboard selected by the user from the custom layout database. The dynamic keyboard is displayed on the touchscreen of the text-entry device.

In yet another exemplary embodiment, the present invention is a computer program stored on a computer readable medium for using a text-entry device having a touchscreen and a database including a plurality of custom keyboard layouts. The computer program includes a first portion for displaying a first dynamic keyboard selected by the user from the custom layout database, a second portion for receiving a layout command, and a third portion for replacing the displayed first dynamic keyboard with a second dynamic keyboard selected by the user from the custom layout database. The dynamic keyboard is displayed on the touchscreen of the text-entry device.

### BRIEF DESCRIPTION OF THE DRAWINGS

FIGS. 1A and 1B show a text-entry device 100 for generating a customizable virtual keyboard, according to an exemplary embodiment of the present invention.

FIGS. 2A, 2B, and 2C show different styles of customizable virtual keyboards, according to exemplary embodiments of the present invention.

FIGS. 3A, 3B, and 3C show customizable twelve-key keyboards on a touchscreen of a text-entry device, according to exemplary embodiments of the present invention.

FIG. 4 shows a flowchart of a method of enhancing a virtual keyboard of a text-entry device, according to an exemplary embodiment of the present invention.

### DETAILED DESCRIPTION OF THE INVENTION

The present invention includes systems and methods for improving the efficiency of text input by generating a dynamic virtual keyboard. Exemplary embodiments of the present invention display a soft keyboard on a touchscreen of a text-entry device. The touchscreen works with the soft keyboard as a form of text input. Keyboard logic on the text-entry device allows the user to select a desired layout for the keyboard, such that the user can change the ergonomics of the keyboard in order to make text input more comfortable. Different layouts reflect different typing styles, hand positions, etc.

The customizable virtual keyboard allows the user to change the shape of the QWERTY or 10-key keyboard to achieve easier and more efficient text entry with less stress to the hand, fingers, and thumbs. Mobile devices allow the user to change the shape and style of keys as well as increments. Exemplary embodiments of the present invention address ergonomics for every text entry customer and customizability for the user to choose the right keypad layout that suits them best without having to buy a different device.

The keyboard either resides in the device as a native client or as a downloadable client, such as a java application, etc., that has Application Programming Interface (API) hooks to the text entry mechanism. The user chooses from a linear keyboard, concave, concave linear, etc. This also allows other users of the same device to change the shape of the keyboard to their needs and preferences. Users can also save their personal settings. The client changes not only the visual layout of the keys but the corresponding touch footprint as well. The user not only chooses the style of the virtual keyboard (linear, concave or V shape) but can also adjust the increment for those keyboards (i.e. make the concave dip greater, the V-shape steeper, etc) to the best fit for them.

Users of the present invention do not have to sacrifice features and functionality of a device simply because the keyboard is not comfortable or easy to use. The user can choose between multiple keyboards for the one that is most ergonomic to them and provides them the best text entry experience. It also allows multiple users of the same devices the ability to not have to sacrifice comfort and preference. The same user can even change the keyboard layout based on the application they are using.

Virtual keyboards are comprised of a visible key, which is the visible portion that the user actually sees, and the actual touch footprint, which is the area of the touchpad that the user can make contact with to register a key entry. While a user does not see a footprint, the footprint must be touched in order for the touchscreen to register the associated key entry. In many cases the footprint will be the exact size and shape of the footprint, but this is not necessary.

“Text-entry device”, as used herein and throughout this disclosure, refers to an electronic device which accepts an alphanumeric input often supplied by a virtual or physical keyboard. Examples of a text-entry device include notebook computers, tablet computers, personal digital assistants (PDAs), cellular telephones, smart phones, etc.

“Touchscreen,” as used herein and throughout this disclosure, refers to a display that can detect and locate a touch on its surface. Examples of types of touchscreen include resistive, which can detect many objects; capacitive, which can detect multiple touches at once; etc.

“Logic,” as used herein and throughout this disclosure, refers to any information having the form of instruction signals and/or data that may be applied to affect the operation of a processor. Examples of processors are computer processors (processing units), microprocessors, digital signal processors, controllers and microcontrollers, etc. Logic may be formed from signals stored in a device memory. Software is one example of such logic. Examples of device memories that may comprise logic include RAM (random access memory), flash memories, ROMS (read-only memories), EPROMS (erasable programmable read-only memories), and EEPROMS (electrically erasable programmable read-only memories). Logic may also be comprised by digital and/or analog hardware circuits, for example, hardware circuits comprising logical AND, OR, XOR, NAND, NOR, and other logical operations. Logic may be formed from combinations of software and hardware.

For the following description, it can be assumed that most correspondingly labeled structures across the figures (e.g., 132 and 232, etc.) possess the same characteristics and are subject to the same structure and function. If there is a difference between correspondingly labeled elements that is not pointed out, and this difference results in a non-corresponding structure or function of an element for a particular embodiment, then that conflicting description given for that particular embodiment shall govern.

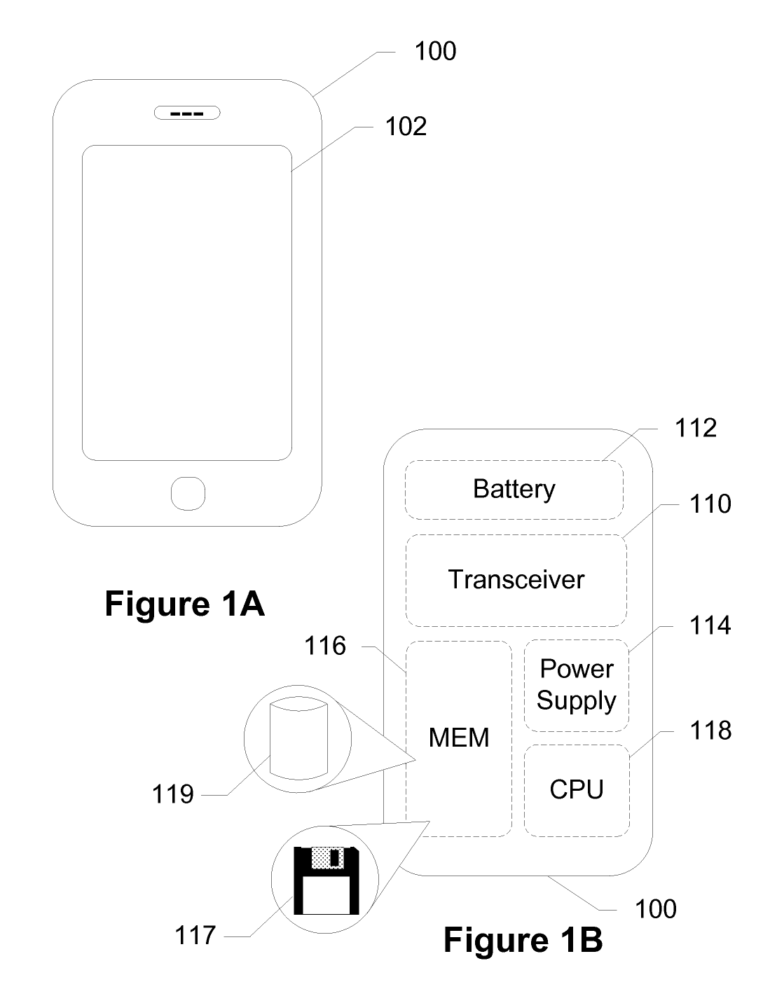

FIGS. 1A and 1B show a text-entry device 100 for generating a customizable virtual keyboard, according to an exemplary embodiment of the present invention. In this embodiment, text-entry device 100 includes a touchscreen 102, a transceiver 110, a battery 112, a power supply 114, a central processing unit (CPU) 118, and a memory 116. Touchscreen 102 is an LCD or LED screen that is touch-sensitive such that a user can make selections on touchscreen 102. This allows the user to type letters, numbers, and symbols in order to create text messages, e-mails, etc. Touchscreen 102 displays a virtual keyboard according to commands sent from CPU 118. Transceiver 110 allows text-entry device 100 to wirelessly communicate with a network, other wireless devices, etc. Battery 112 stores a charge to power components of text-entry device 100. Power supply 114 provides power to each of the components of text-entry device 100. CPU 118 commands components of text-entry device 100 according to logic on memory 116. Memory 116 stores logic, data, etc. Among the logic stored on memory 116 is keyboard logic 117. Keyboard logic 117 displays a virtual keyboard based upon the desired configuration of the user. Keyboard logic 117 references a custom layout database 119 when configuring the virtual keyboard. Custom layout database 119 contains different keyboard configurations as well as customizable options for the keyboard. For instance, the user may change the style and increment of the keyboard to their liking.

There are many other embodiments of a text-entry device that uses a customizable virtual keyboard. The embodiment in FIGS. 1A and 1B is similar to that of a cellular telephone or smart phone. Another exemplary embodiment is a PDA having a dynamic virtual keyboard. The feel is similar to that of FIGS. 1A and 1B since the size of the touchscreen is comparable. Most users will find typing easiest using their thumbs. However, other embodiments accommodate users for finger typing. Another exemplary embodiment features a tablet computer with a dynamic virtual keyboard. A tablet computer typically has a much larger touchscreen than your average PDA and can accommodate a full size soft keyboard. The keyboard logic can make this typing experience just as easy by generating a customizable virtual keyboard.

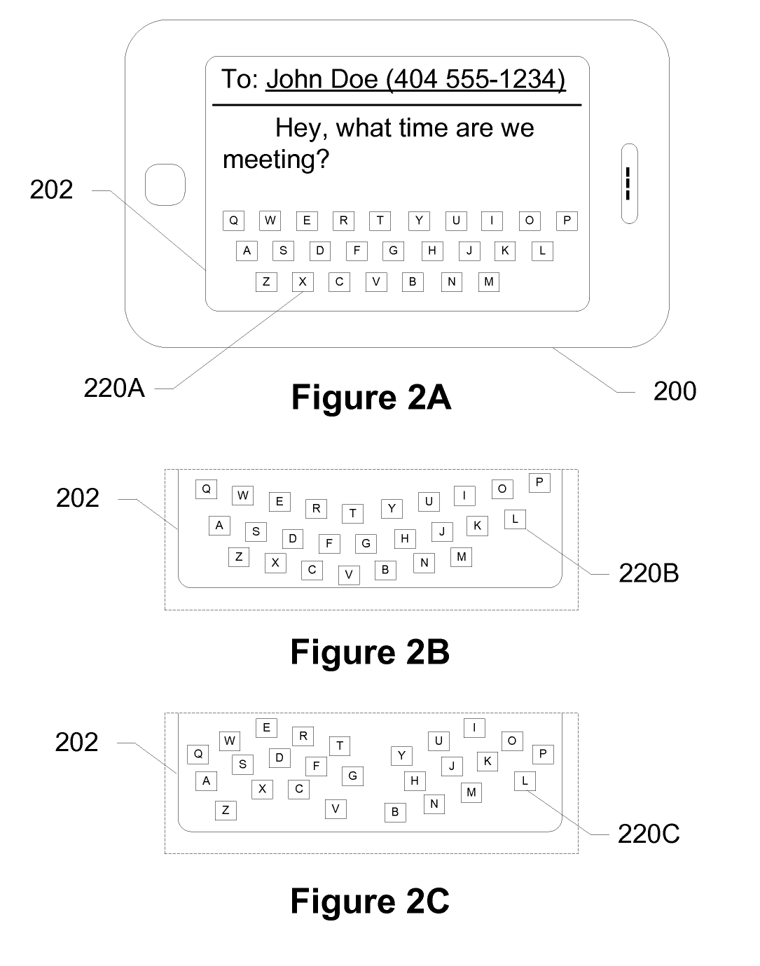

FIGS. 2A, 2B, and 2C show different styles of customizable virtual keyboard, according to exemplary embodiments of the present invention. These figures show examples of different keyboard layouts which may be desired by a user. Some layouts conform to the natural movement of a user's thumb. Layouts such as that in FIG. 2B may be desired by a user that types with their thumbs pivoting from the corners. As the thumbs rotate about the keyboard, the tips travel in a path loosely matching the concave shape. However, the layout in FIG. 2C may be desired by a user that holds their hands closer together and types with their thumbs pivoting from location closer to the center of the bottom of the keyboard. In this case, as the thumbs rotate about the keyboard, the tips travel in a convex motion similar to that of common windshield wipers for vehicles. The layout in FIG. 2A may be desired by a user that prefers a more traditional keyboard.

FIG. 2A shows a customizable virtual keyboard 220A on a touchscreen 202 of a text-entry device 200, according to an exemplary embodiment of the present invention. In this embodiment, the key placement is similar to that of a traditional QWERTY keyboard. Users may desire this style of keypad as it may be to what they have grown accustomed. The user may change the increment of the keys to their liking. For instance, if the user feels the keys are too close together, the user may space the keys farther apart. The user may desire to have the keys slightly angled. These and other changes may be easily set in the keyboard logic. This layout may be suitable as a default for a tablet PC.

FIG. 2B shows a customizable virtual keyboard 220B on a touchscreen 202 of a text-entry device 200, according to an exemplary embodiment of the present invention. In this embodiment, the key placement is designed for a user that primarily types with their thumbs. The keys and their accompanying footprints are focused around where a user generally keeps their thumbs when holding text-entry device 200. As with FIG. 2A, the user may change the increment of the keys to their liking. For instance, a user with longer thumbs may want the keys to be spaced farther apart with longer reaches to certain keys. This may improve their comfort in typing, their accuracy, etc. A user with smaller thumbs may desire the keys to be closer to the placement of their thumbs. This may make the keys closer together, but allows the user to keep their hands in place and still reach all of the keys. Many other increments are possible, such as the slope of the V-shape formed by the keys, the angle of the keys themselves, etc. A user with larger hands may hold the text-entry device with their palms away from each other, making the concave shape of this keyboard more suitable to the path of the thumb tips. Thus, the concave shape of this keyboard may be suitable for a user with larger hands.

FIG. 2C shows a customizable virtual keyboard 220C on a touchscreen 202 of a text-entry device 200, according to an exemplary embodiment of the present invention. In this embodiment, the key placement is designed for a user that primarily types with their thumbs, but wants an ergonomic design. The keys and their accompanying footprints are focused around the path of a user's thumb tips as they pivot about the hands. As such, the keys form convex groupings around the placement of each of the user's thumb paths. As with FIGS. 2A and 2B, the user may change the increment of the keys to their liking. For instance, the user may desire the keys to be more or less convex, closer or farther apart vertically, closer or farther apart horizontally, etc. A user with smaller hands may hold the text-entry device with their palms together, making the dual-convex shape of this keyboard more suitable to the path of the thumb tips. Thus, the convex shape of this keyboard may be suitable for a user with smaller hands.

Many other designs of keyboard layouts will become readily recognizable by those having skill in the art. Some have more support for thumb-typing while others support finger typing more.

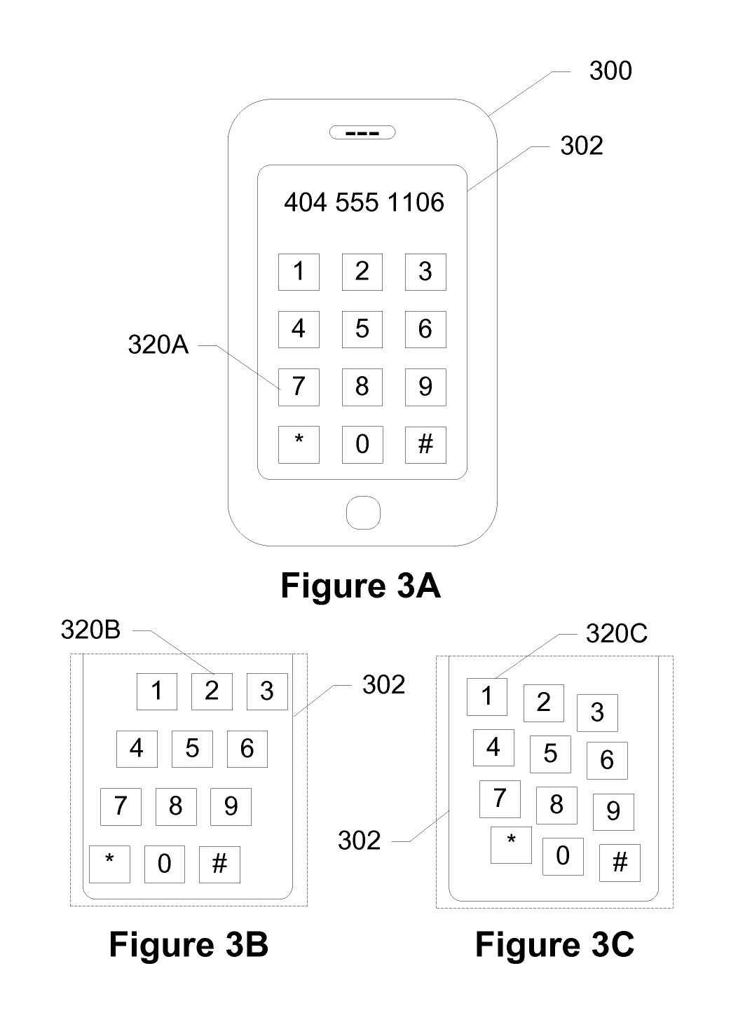

FIGS. 3A, 3B, and 3C show customizable twelve-key keyboards on a touchscreen of a text-entry device, according to an exemplary embodiment of the present invention. As such keyboards are often pressed with the user's thumb, embodiments of the present invention allow for adjusting the placement of keys such that they are easier to press with whichever thumb the user uses.

FIG. 3A shows a customizable 10-key keyboard 320A on a touchscreen 302 of a text-entry device 300. In this embodiment, keyboard 320A is in a default position. This is a position similar to many cellular telephones where each of the keys is spaced equally and keyboard 320A is not skewed to one direction or another. Users who type using fingers other than their thumbs or users who do not always use the same hand during dialing may prefer this type of layout for keyboard 320A.

FIG. 3B shows a customizable 10-key keyboard 320B on a touchscreen 302 of a text-entry device where the keys have been adjusted, according to an exemplary embodiment of the present invention. In this embodiment, the keys have been slightly skewed such that they are more easily reachable by a user holding the text-entry device in their right hand and typing with their thumb. The top row of keys of keyboard 320B are moved to the right, close to the edge of touchscreen 302. The row below the top row of keys is also moved to the right, but not as much, and so on. The bottom row may be in the same location as in FIG. 3A, or may also be moved slightly. This may be to the right or left, depending on what is comfortable to the user. The keys are arranged such that as a right-handed user pivots their thumb about the hand, the thumb-tip travels through the center of the keys of keyboard 302B.

FIG. 3C shows customizable 10-key keyboard 320C on a touchscreen 302 of a text-entry device where the keys have been adjusted, according to an exemplary embodiment of the present invention. In this embodiment, the keys have been slightly skewed such that they are more easily reachable by a user holding the text-entry device in their left hand and typing with their thumb. The top row of keys of keyboard 320C are moved to the left, close to the edge of touchscreen 302. The row below the top row of keys is also moved to the left, but not as much, and so on. The bottom row may be in the same location as in FIG. 3A, or may also be moved slightly. This may be to the right or left, depending on what is comfortable to the user. In addition, the keys have been further compressed along the line of travel of a thumb-tip pivoting about the user's hand while entering a text.

Many other designs of keyboard layouts will become readily recognizable by those having skill in the art. Since dialing numbers or entering text through a numerical 12-key keyboard is usually done with one hand, some keyboards are designed for left-handed users while other keyboards are designed for right-handed users.

In exemplary embodiments of the present invention, logic on the text-entry device may determine which hand of the user is holding the text-entry device. This may be accomplished by the touchscreen detecting an angle of the thumb, etc. In these embodiments, the logic on the text-entry device may automatically switch to a more ergonomic layout for the thumb being used. Automatically switching the layout may be enabled on a user menu stored on the text-entry device.

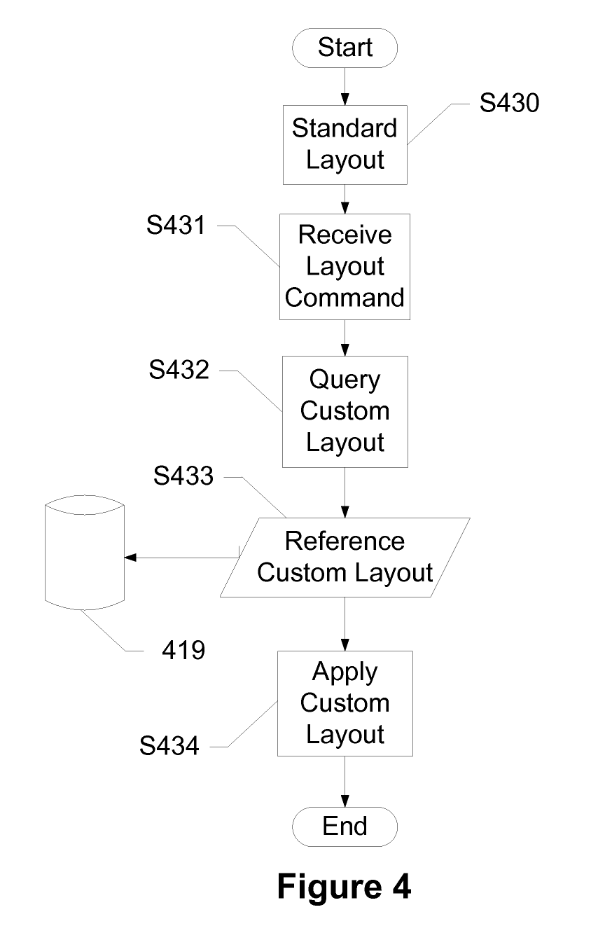

FIG. 4 shows a flowchart of a method of enhancing a virtual keyboard of a text-entry device, according to an exemplary embodiment of the present invention. In this embodiment, each of the keys on a keyboard is in a location according to a standard layout S430. This standard layout may be a standard QWERTY keyboard, a 10-digit keypad, etc. The keyboard receives a layout command S431 from, for example, a key entry. With an input received, keyboard logic on the text-entry device queries the keyboard logic for a custom layout based on the command S432. The keyboard logic then references a custom layout S433. This is accomplished by referencing a database 419 containing stored keyboard layouts. The database informs the keyboard logic of the desired location of each of the keys on the keyboard. The keyboard logic then applies the custom layout S434 by instructing the CPU of the text-entry device to command the touchscreen to display the desired layout.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A text-entry device for generating a dynamic virtual keyboard comprising:
a processor;
a memory in communication with the processor;
a touchscreen in communication with the processor;
a keyboard logic stored on the memory; and
a custom layout database stored on the memory;
wherein the keyboard logic displays a dynamic keyboard selected by the user from the custom layout database on the touchscreen.

2. The device in claim 1, wherein the custom layout database includes a plurality of custom keyboard layouts.

3. The device in claim 2, wherein the custom layout database includes QWERTY keyboards and 12-key keyboards.

4. The device in claim 2, wherein the custom layout database includes left-handed keyboards and right-handed keyboards.

5. The device in claim 2, wherein the custom layout database includes keyboards having a plurality of keys arranged to conform to the natural movement of a user's thumb.

6. The device in claim 1, further comprising a transceiver.

7. The device in claim 6, wherein the transceiver uses one of cellular RF, BLUETOOTH, and WiFi.

8. A method of using a text-entry device having a touchscreen and a database including a plurality of custom keyboard layouts comprising:
displaying a first dynamic keyboard selected by the user from the custom layout database;
receiving a layout command; and
replacing the displayed first dynamic keyboard with a second dynamic keyboard selected by the user from the custom layout database;
wherein the dynamic keyboard is displayed on the touchscreen of the text-entry device.

9. The method of claim 8, wherein the receiving further comprises receiving input from the user.

10. The method of claim 8, wherein the displaying further comprises skewing the keyboard for a right-handed user.

11. The method of claim 8, wherein the displaying further comprises skewing the keyboard for a left-handed user.

12. The method of claim 8, further comprising resetting the displayed second dynamic keyboard with a standard layout keyboard.

13. A computer program stored on a computer readable medium for using a text-entry device having a touchscreen and a database including a plurality of custom keyboard layouts comprising;
a first portion for displaying a first dynamic keyboard selected by the user from the custom layout database;
a second portion for receiving a layout command; and
a third portion for replacing the displayed first dynamic keyboard with a second dynamic keyboard selected by the user from the custom layout database;
wherein the dynamic keyboard is displayed on the touchscreen of the text-entry device.

14. The computer program of claim 13, wherein the second portion further comprises receiving input from the user.

15. The computer program of claim 13, wherein the first portion further comprises skewing the keyboard for a right-handed user.

16. The computer program of claim 13, wherein the first portion further comprises skewing the keyboard for a left-handed user.

17. The computer program of claim 13, further comprising resetting the displayed second dynamic keyboard with a standard layout keyboard.
